(19) United States
(12) Patent Application Publication
(10) Pub. No.: US 2022/0138267 A1
(43) Pub. Date: May 5, 2022

(54) GENERATION APPARATUS, LEARNING APPARATUS, GENERATION METHOD AND PROGRAM

(71) Applicant: NIPPON TELEGRAPH AND TELEPHONE CORPORATION, Tokyo (JP)

(72) Inventors: Atsushi OTSUKA, Tokyo (JP); Kyosuke NISHIDA, Tokyo (JP); Itsumi SAITO, Tokyo (JP); Kosuke NISHIDA, Tokyo (JP); Hisako ASANO, Tokyo (JP); Junji TOMITA, Tokyo (JP)

(73) Assignee: NIPPON TELEGRAPH AND TELEPHONE CORPORATION, Tokyo (JP)

(21) Appl. No.: 17/431,760

(22) PCT Filed: Feb. 12, 2020
(86) PCT No.: PCT/JP2020/005318

§ 371 Date: Aug. 18, 2021

(30) Foreign Application Priority Data
Feb. 20, 2019 (JP) 2019-028504

(51) Int. Cl. G06F 16/9032; G06N 3/04

(52) U.S. Cl. CPC G06F 16/90332; G06N 3/0472; G06N 3/0454

(57) ABSTRACT

A generation apparatus includes a generation unit configured to use a machine learning model learned in advance, with a document as an input, to generate a question representation for a range of an answer in the document, wherein when generating a word of the question representation by performing a copy from the document, the generation unit adjusts a probability that a word included in the range is copied.

### TECHNICAL FIELD

The present invention relates to a generation apparatus, a learning apparatus, a generation method and a program.

### BACKGROUND ART

Question generation is a task of automatically generating a question (question sentence) related to a passage described in a natural language when the passage is given.

In recent years, a technique is available in which a part extracted from a passage is given to a question generation model as an answer to generate a question focusing only on an answer part (see, e.g., NPTL 1). With such a technique, when a passage “NTT held the R&D Forum 2018 in Musashino City, Tokyo on Nov. 29, 2018” is used and “NTT” extracted from the passage is given to a question generation model as an answer, a question asking for the company name, such as “the company that held the R&D forum?”, is generated, for example. Likewise, when “Nov. 29, 2018” is given to a question generation model as an answer, a question asking for the timing, such as “When did NTT hold R & D Forum 2018?”, is generated, for example.

### CITATION LIST

### Non Patent Literature

[NPTL 1] Xinya Du, Claire Cardie, “Harvesting Paragraph-Level Question-Answer Pairs from Wikipedia”, ACL2018

### SUMMARY OF THE INVENTION

### Technical Problem

In the known question generation, a question using a word and the like of a range given to the question generation model as an answer in a passage (i.e., a range of an answer part extracted from a passage) as they are is generated in some situation. As such, for example, a question that can be answered by YES/NO, which is difficult to use in chatbots and FAQ searching as applications of the question generation task, is generated in some situation.

Under such a circumstance, an object of the present invention is to prevent a word included in an answer range in a passage from being used in generation of a question related to an answer.

### Means for Solving the Problem

To achieve the above-described object, a generation apparatus of an embodiment of the present invention includes a generation unit configured to use a machine learning model learned in advance, with a document as an input, to generate a question representation for a range of an answer in the document, wherein when generating a word of the question representation by performing a copy from the document, the generation unit adjusts a probability that a word included in the range is copied.

### Effects of the Invention

It is possible to prevent a word included in an answer range in a passage from being used in generation of a question related to an answer.

### BRIEF DESCRIPTION OF DRAWINGS

FIG. 1 is a drawing illustrating an example of a functional configuration (in generation of answers and questions) in a generation apparatus of an embodiment of the present invention.

FIG. 2 is a drawing illustrating an example of a functional configuration (in learning) in the generation apparatus of the embodiment of the present invention.

FIG. 3 is a drawing illustrating an example of a hardware configuration of the generation apparatus of the embodiment of the present invention.

FIG. 4 is a flowchart illustrating an example of an answer and question generation process of the embodiment of the present invention.

FIG. 5 is a flowchart illustrating an example of a learning process of the embodiment of the present invention.

FIG. 6 is a drawing for describing examples of answers and questions.

FIG. 7 is a drawing illustrating a modification of the functional configuration (in generation of answers and questions) of the generation apparatus of the embodiment of the present invention.

### DESCRIPTION OF EMBODIMENTS

An embodiment of the present invention is elaborated below with reference to the drawings. In the following description of the embodiment of the present invention, a generation apparatus 10 using a question generation model (hereinafter referred to also simply as “generation model”) described later is described. Here, with a passage as an input, the question generation model generates a range that is likely to be an answer in the passage, and a question related to the answer at the same time. In the embodiment of the present invention, by utilizing a model of machine reading used for question and answer and data set, a plurality of range that is likely to be an answer in a passage (answer range) are extracted, and then questions whose answers are the answer ranges are generated. In this manner, when generating a question related to an answer, it is not necessary to specify the range of an answer in a passage. In contrast, in a conventional technology, it is necessary to specify a range of an answer in a passage when generating a question related to an answer.

Note that in the embodiment of the present invention, the generation model is a machine learning model using a neural network. It should be noted that a plurality of neural networks may be used for the generation model. In addition, a machine learning model other than the neural network may be used for the generation model in part or in its entirety.

Here, in a conventional question generation, a question based on a content in a passage is generated, and therefore words and the like of the question are used (copied) as they are from the passage. As such, a question using a word and the like included in a range corresponding to a given answer from the passage as they are is generated in some situation, for example. For example, for an answer range “Nov. 29, 2018”, a question “NTT held R&D Forum 2018 on Nov. 29, 2018?” or the like, which can be answered by YES/NO, is generated in some situation. Such a question that can be answered by YES/NO is difficult to use in chatbots, FAQ searching and the like as applications of a question generation task, for example, and it is therefore preferable that questions that can be answered by YES/NO not be generated.

In view of this, the embodiment of the present invention adopts, for a generation model, a mechanism of preventing a copy from an answer range when generating a question by copying a word and the like in a passage. To be more specific, when generating a question by copying a word and the like in a passage, the probability that the word and the like are copied from an answer range is adjusted such that the probability is low (which includes a case where an adjustment is performed such that the probability is zero). In this manner, the question is generated with a word and the like copied from a part other than the answer range, and thus it is possible to prevent generation of a question that can be answered by YES/NO.

Functional Configuration of Generation Apparatus 10

In the embodiment of the present invention, a phase of generating answers and questions using a learned generation model (generation of answers and questions), and a phase of learning the generation model (learning) are provided.

Generation of Answers and Questions

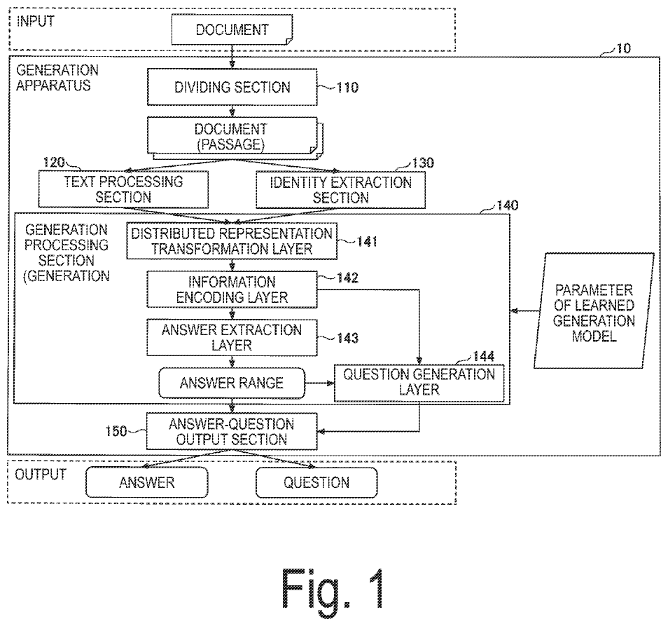

First, a functional configuration of the generation apparatus 10 in generation of answers and questions is described with reference to FIG. 1. FIG. 1 is a drawing illustrating an example of a functional configuration (generation of answers and questions) of the generation apparatus 10 of the embodiment of the present invention.

As illustrated in FIG. 1, the generation apparatus 10 in generation of answers and questions includes, as functional sections, a dividing section 110, a text processing section 120, an identity extraction section 130, a generation processing section 140, and an answer-question output section 150. In the embodiment of the present invention, in generation of answers and questions, a document (such as a manual) described in a natural sentence is input to the generation apparatus 10. Note that this document may be a document obtained through voice recognition of a voice input to the generation apparatus 10 or other apparatuses, for example.

The dividing section 110 divides an input document into one or more passages. Here, in the case where the input document is a long sentence and the like, it is difficult to process the entire document by the generation model. In view of this, the dividing section 110 divides the input document into passages having a length (e.g., passages of several hundred to several thousand words in length) that can be processed by the generation model. Note that the document divided by the dividing section 110 may be referred to as “partial document” or the like.

Any method may be used as the method of dividing an input document into one or more passages. For example, each paragraph of a document may be divided into passages, or when a document has a structure of hypertext markup language (HTML) format or the like, the document may be divided into passages using meta information such as a tag. In addition, for example, the user may create his or her own a division rule that specifies the number of letters included in one passage and the like so as to make a division into passages based on the division rules.

The following text processing section 120, identity extraction section 130, generation processing section 140 and answer-question output section 150 execute processes in a passage unit. Accordingly, when a document is divided by the dividing section 110 into a plurality of passages, the identity extraction section 130, the generation processing section 140 and the answer-question output section 150 repeatedly execute a process for each passage.

The text processing section 120 transforms a passage to a format that can be input to a generation model. A distributed representation transformation layer 141 described later performs a transformation to distributed representations in a word unit, and therefore the text processing section 120 transforms a passage to a word sequence represented by a format divided in a word unit (e.g., a format in which words are separated in a word unit with half-width spaces, and the like). Here, as a transformation format for transforming a passage to a word sequence, any format may be used as long as a transformation to distributed representations can be performed at the distributed representation transformation layer 141 described later. For example, a passage in English can be converted to a word sequence using words separated by half-width spaces as they are, and can be converted to a word sequence of a format in which words are divided into subwords. In addition, for example, a passage in Japanese may be converted to a word sequence by performing morphological analysis on the passage so as to use morphemes obtained by the morphological analysis as words and separate the words by half-width spaces. Note that any analyzer may be used as a morphological analyzer.

The identity extraction section 130 extracts information effective for generation of answers and questions as identity information from the passage. As this identity information, any identity information may be used as long as a transformation to distributed representations can be performed at the distributed representation transformation layer 141 described later. For example, as in the above-described NPTL 1, reference relationships of words and/or sentences may be used as identity information, or a named entity extracted from a passage may be used as identity information. Note that the identity information may be simply referred to as “identity”, or as “characteristic” or “characteristic amount” or the like. In addition, the case where identity information is extracted from the passage is not limitative, and, for example, identity information may be acquired from outside such as another apparatus connected through a communication network.

A named entity is a specific representation (such as a proper noun) extracted from a passage, to which a category label has been added. Examples of a named entity include a proper noun “NTT” to which a label “office” has been added, and a date “Nov. 29, 2018” to which a label “date” has been added. Such named entities are useful information to specify the type of a question generated by the generation model. For example, it is possible to specify that when a label “date” is added to a word or the like in an answer range, a question of a type for asking date and/or timing, such as “when . . . ?”, should be generated. In addition, for example, it is possible to specify that when a label “office” is added to a word or the like in an answer range, a question of a type for asking a company name, such as “company that . . . ?”, should be generated. Note that other various question types than the above-described question types may be used in accordance with category labels.

The generation processing section 140 is implemented with a generation model using a neural network. The generation processing section 140 uses a parameter of a learned generation model to extract a plurality of ranges (answer ranges) that are likely to be answers in a passage, and generate questions whose answers are the answer ranges. Here, the generation processing section 140 (i.e., a generation model using a neural network) includes the distributed representation transformation layer 141, an information encoding layer 142, an answer extraction layer 143, and a question generation layer 144. Note that these layers implement respective functions in the case where the generation model using the neural network is functionally divided, and may be referred to as “sections” instead of “layers”.

The distributed representation transformation layer 141 transforms a word sequence transformed by the text processing section 120 and identity information extracted by the identity extraction section 130 to a distributed representation to be handled in the generation model.

Here, first, the distributed representation transformation layer 141 transforms each identity information and each word of the word sequence to a one-hot vector. For example, the text processing section 120 transforms each word to a V-dimensional vector in which only an element corresponding to the word is set as 1 and another element is set as 0, where V is the total number of words used in the generation model. Likewise, for example, the text processing section 120 transforms each identity information to an F-dimensional vector in which only an element corresponding to the identity information is set as 1 and another element is set as 0, where F is the number of types of identity information used in the generation model.

Next, the distributed representation transformation layer 141 uses a transformation matrix Mw∈RV×d to transform the one-hot vector of each word to a d-dimensional real-valued vector (this real-valued vector is hereinafter referred to also as “word vector”). Note that R indicates an entire set of real numbers.

Likewise, the distributed representation transformation layer 141 uses a transformation matrix Mf∈RF×d′ to transform the one-hot vector of each identity information to a d′-dimensional real-valued vector (this real-valued vector hereinafter referred to also as “identity vector”).

Note that the above-described transformation matrices Mw and Mf may be learned as parameters of a learning object when learning a generation model, or an existing distributed representation model such as learned Word2Vec may be used.

The information encoding layer 142 uses a set of word vectors obtained by the distributed representation transformation layer 141 to encode these word vectors to a vector sequence H∈Rd×T in consideration of the mutual relationships between words. Here, T indicates a sequence length of word vectors (i.e., the number of elements of a word vector set).

Note that any method may be used as the method of encoding a word vector set as long as the above-described vector sequence H can be obtained. For example, a recurrent neural network may be used to perform the encoding to the vector sequence H, or a method using a self-attention may be used to perform the encoding to the vector sequence H.

Here, the information encoding layer 142 may encode a set of word vectors, while at the same time performing encoding that also incorporates a set of identity vectors obtained by the distributed representation transformation layer 141. Note that any method may be used as the method of encoding that also incorporates the identity vector set. For example, when a sequence length of identity vectors (i.e., the number of elements of an identity vector set) is identical to a sequence length T of word vectors, the generation processing section 140 may obtain a vector sequence by the three methods described below. In the first method, a vector sequence H∈R(d+d′)×T taking also identity information into consideration is obtained using a vector in which a word vector and an identity vector are connected (d+d′-dimensional vector) as an input of the information encoding layer 142. In the second method, vector sequences H1 and H2 are obtained by encoding a set of word vectors and a set of identity vectors in the same encoding layer or in different encoding layers, and then vector sequence H taking also identity information into consideration is obtained by connecting each vector of vector sequence H1 and each vector of vector sequence H2. In the third method, a vector sequence H taking also identity information into consideration is obtained by utilizing layers of neural network such as fully connected layers.

Note that the information encoding layer 142 may perform encoding that incorporates an identity vector set, or encoding that does not incorporate an identity vector set. In the case where the information encoding layer 142 performs encoding that does not incorporate an identity vector set, the generation apparatus 10 may not include the identity extraction section 130 (in this case, no identity vector is created because no identity information is input to the distributed representation transformation layer 141).

Note that in the following, the vector sequence H obtained by the information encoding layer 142 is H∈Ru×T. Here, u is u=d when encoding that incorporates an identity vector set is not performed, and is u=d+d′ when encoding that also incorporates an identity vector set is performed.

The answer extraction layer 143 uses the vector sequence H∈Ru×T obtained by the information encoding layer 142 to extract a start point and an end point of a description of an answer from a passage. When a start point and an end point are extracted, the range from the start point to the end point is set as an answer range.

For the start point, a start point vector Ostart∈RT is created by performing linear transformation on the vector sequence H with a weight W0∈R1×u. Then, after a transformation to a probability distribution Pstart is performed by applying a softmax function by the sequence length T for a start point vector Ostart, the s-th (0≤s<T) element having a highest probability among the elements of the start point vector Ostart is set as the start point.

For the end point, first, anew modeling vector M′∈ERu×T is created by inputting the start point vector Ostart and the vector sequence H to a recurrent neural network. Next, an end point vector Oend∈RT is created by performing a linear transformation on the modeling vector M′ with a weight W0. Then, after a transformation to a probability distribution Pend is performed by applying a softmax function by the sequence length T for the end point vector Oend, the eth (0≤e<T) element having a highest probability among the elements of the end point vector Oend is set as the end point. In this manner, the section from the s-th word to the eth word in a passage is set as the answer range.

Here, N answer ranges can be obtained by extracting N start points and end points by the following (1-1) and (1-2) using the above-described Pstart and Pend. Note that N is a hyperparameter set by the user.

(1-1) for a given (i, j) that satisfies 0≤J<T and i≤j<T where T indicates a sequence length, i indicates start point, and j indicates an end point, P(i, j)=Pstart (i)×Pend (j) is calculated.

(1-2) The top N (i, j) of P(i, j) are extracted.

In this manner, N answer ranges are obtained. These answer ranges are input to the question generation layer 144. Note that the answer extraction layer 143 may output N answer ranges, or may output sentences corresponding to respective N answer ranges (i.e., sentences (answer sentences) composed of words and the like included in answer ranges in a passage) as an answer.

Here, in the embodiment of the present invention, the N answer ranges are obtained in such a manner that at least part of each answer range does not overlap. For example, in the case where the first answer range is (i1, j1), and the second answer range is (i₂, j₂) the second answer range is required to satisfy a condition “i₂<i₁ and j₂<i₁” or a condition “i₂>j₁ and j₂>j₁”. An answer range that at least partially overlaps another answer range is not extracted.

With inputs of the answer range and the vector sequence H, the question generation layer 144 generates a word sequence of a question. For generation of word sequences, one based on a recurrent neural network used in the encoder-decoder model disclosed in the following Reference 1 is used, for example.

### REFERENCE 1

Ilya Sutskever, Oriol Vinyals, Quoc V. Le, “Sequence to Sequence Learning with Neural Networks”, NIPS2014

Here, for generation of words, a weighted sum of a generation probability pg of a word output by a recurrent neural network and a probability pc of copying and using a word in a passage is determined. That is, a generation probability p of a word is represented by the following Equation (1).

p=λpg+(1−λ)pc (1)

Here, λ indicates a parameter of a generation model. The copy probability pc is calculated with a weight value by Attention as with the pointer-generator-network disclosed in the following Reference 2.

### REFERENCE 2

Abigail See, Peter J. Liu, Christopher D. Manning, “Get To The Point: Summarization with Pointer-Generator Networks”, ACL2018

That is, when generating a word ws, which is the s-th word of a question to be generated, the probability that a word wt, which is the t-th word in a passage, is copied is calculated by the following Equation (2).

$$\begin{matrix}Expression 1 & \\ {p}_{c} ( {w}_{t} ) = \frac{score ( {H}_{t} , {h}_{s} )}{{\sum }_{t < T} score ( {H}_{t} , {h}_{s} )} & ( 2 )\end{matrix}$$

Here, Ht indicates a t-th vector of a vector sequence H, and hs indicates an s-th state vector of a decoder. In addition, score (·) is a function that outputs a scalar value for determining a weight value of attention, and any function may be used for it. Note that the copy probability of a word that is not included in a passage is 0.

Incidentally, when the word wt is a word that is included in the answer range, the probability pc that the word wt included in the answer range is copied is calculated by the above-described Equation (2). As described above, when generating a word of a question, it is preferable that it is not copied from words included in an answer range. In view of this, in the embodiment of the present invention, pc(wt) is set to 0 when the word wt is included in the answer range. For example, when the word wt is included in the answer range, the negative infinity (or, e.g., a significantly small value such as the 30th power of −10) is set to the score (Ht, hs) in the above-described Equation (2). Since the above-described Equation (2) is a softmax function, the probability is 0 when the negative infinity is set (the probability is significantly small when a significantly small value is set), and thus the copy of the word wt from the answer range can be prevented (or reduced).

Note that a process for preventing copying of the word wt in a passage is referred to also as “mask process”. Prevention of copying of the word wt included in the answer range means provision of a mask process to the answer range.

Here, the range in which the mask process is performed is not limited to the answer range, and may be freely set by the user and the like in accordance with the property of a passage and the like for example. For example, the mask process may be provided to all character string parts that match the character string within the answer range in a passage (i.e., a part including the same character string as that of the answer range in a passage).

The answer-question output section 150 outputs an answer indicated by the answer range extracted by the generation processing section 140 (i.e., an answer sentence composed of words and the like included in an answer range in a passage), and a question corresponding to this answer. Note that a question corresponding to an answer is a question generated by inputting the answer range indicated by the answer to the question generation layer 144.

Learning

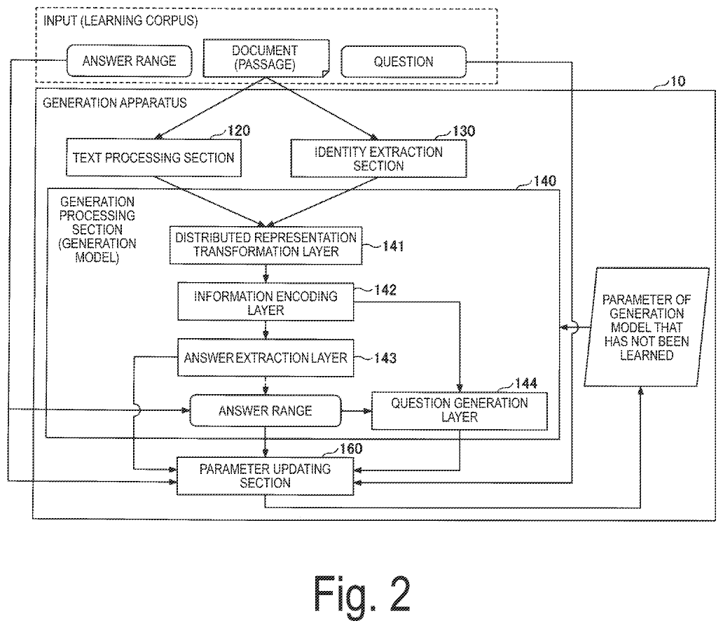

Next, a functional configuration of the generation apparatus 10 in learning is described with reference to FIG. 2. FIG. 2 is a drawing illustrating an example of a functional configuration (in learning) of the generation apparatus 10 of the embodiment of the present invention.

As illustrated in FIG. 2, the generation apparatus 10 in learning includes, as functional sections, the text processing section 120, the identity extraction section 130, the generation processing section 140, and a parameter updating section 160. In the embodiment of the present invention, in learning, a learning corpus of machine reading is input. The learning corpus of machine reading is composed of a group of three elements including a question, a passage, and an answer range. With this learning corpus as training data, the generation apparatus 10 learns a generation model. Note that questions and passages are described in natural sentences.

The functions of the text processing section 120 and the identity extraction section 130 are the same as those of the generation of answers and questions, and therefore the description thereof will be omitted. In addition, the functions of the distributed representation transformation layer 141, the information encoding layer 142 and the answer extraction layer 143 of the generation processing section 140 are the same as those of the generation of answers and questions, and therefore the description thereof will be omitted. It should be noted that the generation processing section 140 uses a parameter of a generation model that has not been learned to execute each process.

While the question generation layer 144 of the generation processing section 140 generates a word sequence of a question with the answer range and the vector sequence H as inputs, an answer range included in the learning corpus (hereinafter referred to also as “correct answer range”) is input as the answer range, in learning.

Alternatively, in accordance with the progress in learning (e.g., an epoch number and the like), the correct answer range, or an answer range output from the answer extraction layer 143 (hereinafter referred to also as “estimated answer range”) may be input. At this time, if the estimated answer range is used as an input from an initial phase of learning, the learning may not converge. In view of this, a probability Pa for setting the estimated answer range as an input is set as a hyperparameter, and whether the correct answer range or the estimated answer range is used as the input is determined based on the probability Pa. For the probability Pa, a function in which the value is relatively small (such as 0 to 0.05) in an initial phase of learning, and the value gradually increases as the learning progresses is set. Such a function may be set by any calculation method.

The parameter updating section 160 uses an error between the correct answer range and the estimated answer range, and an error between a question output from the question generation layer 144 (hereinafter referred to also as “estimated question”) and a question included in the learning corpus (hereinafter referred to also as “correct question”) to update a parameter of a generation model that has not been learned by a known optimization method such that these errors are minimized.

Hardware Configuration of Generation Apparatus 10

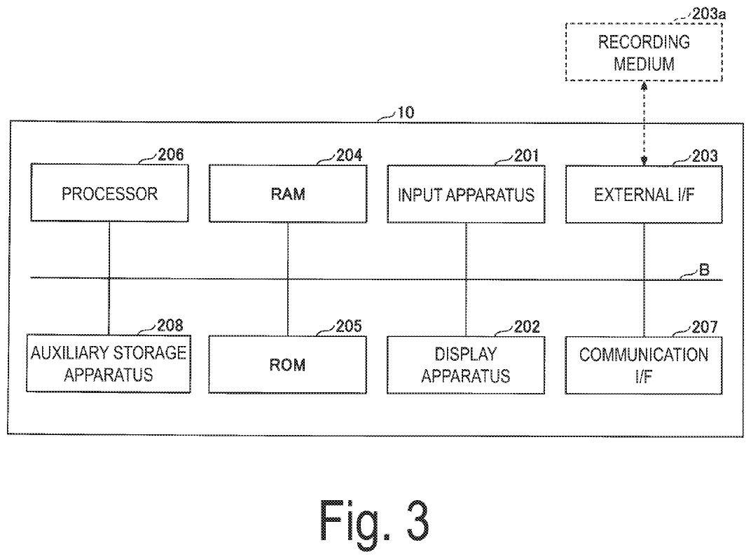

Next, a hardware configuration of the generation apparatus 10 of the embodiment of the present invention is described with reference to FIG. 3. FIG. 3 is a drawing illustrating an example of a hardware configuration of the generation apparatus 10 of the embodiment of the present invention.

As illustrated in FIG. 3, the generation apparatus 10 of the embodiment of the present invention includes, as hardware, an input apparatus 201, a display apparatus 202, an external I/F 203, a random access memory (RAM) 204, a read only memory (ROM) 205, a processor 206, a communication I/F 207, and an auxiliary storage apparatus 208. Each hardware is communicatively connected through a bus B.

The input apparatus 201 is, for example, a keyboard, a mouse, a touch panel or the like, and is used by the user to input various operations. The display apparatus 202 is, for example, a display or the like, and displays results of processes (such as generated answers and questions) of the generation apparatus 10. Note that the generation apparatus 10 may not include at least one of the input apparatus 201 and the display apparatus 202.

The external I/F 203 is an interface for an external recording medium such as a recording medium 203a. The generation apparatus 10 can perform reading and writing from and to the recording medium 203a through the external I/F 203. In the recording medium 203a, one or more programs for implementing the functional sections (e.g., the dividing section 110, the text processing section 120, the identity extraction section 130, the generation processing section 140, the answer-question output section 150, the parameter updating section 160 and the like) of the generation apparatus 10, parameters of a generation model and the like may be recorded.

Examples of the recording medium 203a include a flexible disk, a compact disc (CD), a digital versatile disk (DVD), a secure digital (SD) memory card, and a universal serial bus (USB) memory card.

The RAM 204 is a volatile semiconductor memory for temporarily hold programs and/or data. The ROM 205 is a nonvolatile semiconductor memory that can hold programs and/or data even when the power is turned off. In the ROM 205, setting information related to an operating system (OS), setting information related to communication network and the like are stored, for example.

The processor 206 is, for example, a central processing unit (CPU), a graphics processing unit (GPU) or the like, and is a computation apparatus that reads programs and/or data from the ROM 205, the auxiliary storage apparatus 208 and/or the like to the RAM 204 to execute processes. The functional sections of the generation apparatus 10 are implemented when one or more programs stored in the ROM 205, the auxiliary storage apparatus 208 and/or the like are read to the RAM 204 and the processor 206 executes the processes.

The communication I/F 207 is an interface for connecting the generation apparatus 10 to a communication network. One or more programs for implementing the functional sections of the generation apparatus 10 may be acquired (downloaded) from a predetermined server and the like through the communication I/F 207.

The auxiliary storage apparatus 208 is, for example, a hard disk drive (HDD), a solid state drive (SSD) or the like, and is a nonvolatile storage apparatus that stores programs and/or data. Examples of the programs and/or data stored in the auxiliary storage apparatus 208 include an OS, an application program for implementing various functions on the OS, one or more programs for implementing the functional sections of the generation apparatus 10, and a parameter of generation model.

With the hardware configuration illustrated in FIG. 3, the generation apparatus 10 of the embodiment of the present invention can implement an answer and question generation process and a learning process described later. Note that while the generation apparatus 10 of the embodiment of the present invention is implemented with a single apparatus (computer) in the example illustrated in FIG. 3, the present invention is not limited to this. The generation apparatus 10 of the embodiment of the present invention may be implemented with a plurality of apparatuses (computers). In addition, a single apparatus (computer) may include a plurality of the processors 206, and a plurality of memories (the RAM 204, the ROM 205, the auxiliary storage apparatus 208 and the like).

Answer and Question Generation Process

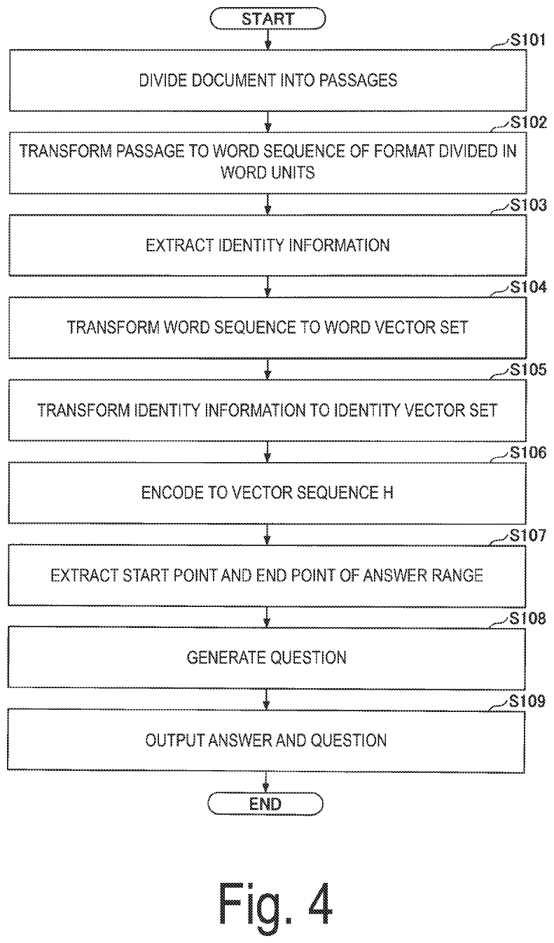

Next, a process of generating answers and questions (answer and question generation process) at the generation apparatus 10 of the embodiment of the present invention is described with reference to FIG. 4. FIG. 4 is a flowchart illustrating an example of an answer and question generation process of the embodiment of the present invention. Note that in the answer and question generation process, the generation processing section 140 uses a parameter of a learned generation model.

Step S101: The dividing section 110 divides an input document into one or more passages.

Note that while a document is input to the generation apparatus 10 in the embodiment of the present invention, the step S101 may not be performed in the case where a passage is input to the generation apparatus 10, for example. In this case, the generation apparatus 10 may not include the dividing section 110.

Subsequent step S102 to step S107 are repeatedly executed for each passage obtained by the division at the step S101.

Step S102: Next, the text processing section 120 transforms a passage to a word sequence represented in a format divided in word units.

Step S103: Next, the identity extraction section 130 extracts identity information from the passage.

Note that the step S102 and step S103 are executed in no particular order. Step S102 may be executed after step S103 is executed, or step S102 and step S103 may be executed in parallel. In addition, the step S103 may not be performed in the case where the identity information is not taken into consideration when encoding a word vector set to a vector sequence H at step S106 described later (i.e., when the identity vector set is not incorporated in the encoding).

Step S104: Next, the distributed representation transformation layer 141 of the generation processing section 140 transforms the word sequence obtained at the step S102 to a word vector set.

Step S105: Next, the distributed representation transformation layer 141 of the generation processing section 140 transforms the identity information obtained at the step S103 to an identity vector set.

Note that the step S104 and step S105 are executed in no particular order. Step S104 may be executed after step S105 is executed, or step S104 and step S105 may be executed in parallel. In addition, the step S105 may not be performed in the case where the identity information is not taken into consideration when encoding a word vector set to a vector sequence H at step S106 described later.

Step S106: Next, the information encoding layer 142 of the generation processing section 140 encodes the word vector set obtained at the step S104 to a vector sequence H. At this time, the information encoding layer 142 may perform the encoding incorporating an identity vector set.

Step S107: The answer extraction layer 143 of the generation processing section 140 uses the vector sequence H obtained at the step S106 to extract a start point and an end point of each of N answer ranges.

Step S108: The question generation layer 144 of the generation processing section 140 generates an answer for each of the N answer ranges obtained at the step S107.

Step S109: The answer-question output section 150 outputs N answers indicated by the N answer ranges obtained at the step S107, and questions corresponding to the respective N answers. Note that the output destination of the answer-question output section 150 may be any output destination. For example, the answer-question output section 150 may output the N answers and questions to the auxiliary storage apparatus 208, the recording medium 203a and/or the like to store them, or may output them to the display apparatus 202 to display them, or, may output them to another apparatus and the like connected to through a communication network.

Learning Process

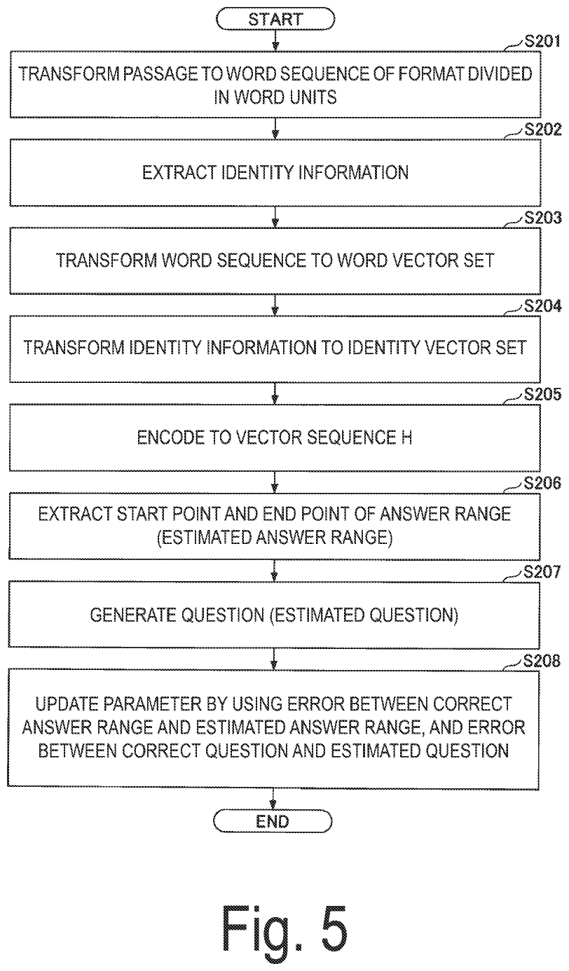

Next, a process of learning a generation model (learning process) by the generation apparatus 10 of the embodiment of the present invention is described with reference to FIG. 5. FIG. 5 is a flowchart illustrating an example of a learning process of the embodiment of the present invention. Note that in the learning process, the generation processing section 140 uses a parameter of a generation model that has not been learned.

Step S201 to step S205 are identical to step S102 to step S106 of the answer and question generation process, and therefore the description thereof will be omitted.

Step S206: The answer extraction layer 143 of the generation processing section 140 uses the vector sequence H obtained at step S205 to extract a start point and an end point of each of the N answer ranges (estimated answer ranges).

Step S207: Next, the question generation layer 144 of the generation processing section 140 generates an estimated question for the input correct answer range (or, the estimated answer range obtained at the step S206).

Step S208: The parameter updating section 160 uses an error between the correct answer range and the estimated answer range and an error between the estimated question and the correct question to update a parameter of a generation model that has not been learned. In this manner, the parameter of the generation model is updated. By repeatedly executing the parameter update for each learning corpus of machine reading, the generation model is learned.

Result of Generation of Answers and Questions

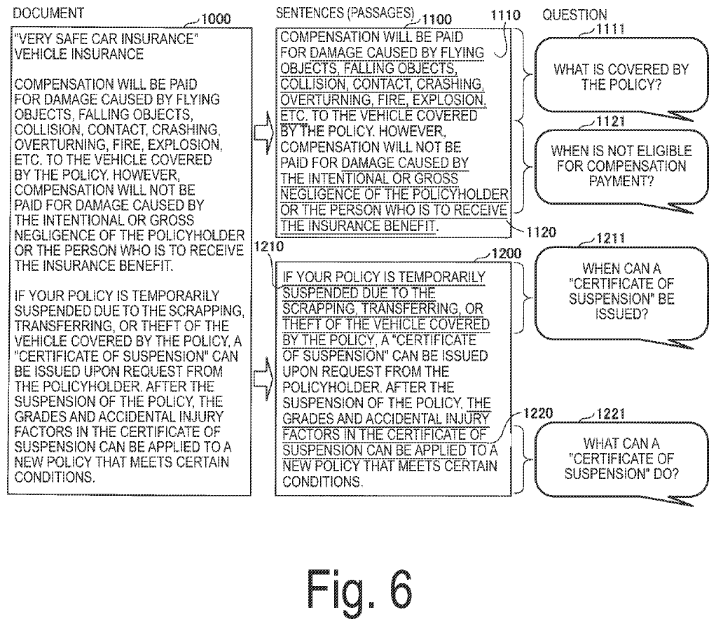

Now, a result of generation of answers and questions through the answer and question generation process is described with reference to FIG. 6. FIG. 6 is a drawing for describing examples of answers and questions.

When a document 1000 illustrated in FIG. 6 is input to the generation apparatus 10, it is divided into a passage 1100 and a passage 1200 at step S101 in FIG. 4. Then, by executing step S103 to step S107 in FIG. 4 for each of the passage 1100) and the passage 1200, an answer range 1110 and an answer range 1120 are extracted for the passage 1100, and an answer range 1210 and an answer range 1220 are extracted for the passage 1200.

Then, by executing step S108 in FIG. 4, a question 1111 corresponding to the answer indicated by the answer range 1110 and a question 1121 corresponding to the answer indicated by the answer range 1120 are generated for the passage 1100. Likewise, a question 1211 corresponding to the answer indicated by the answer range 1210 and a question 1221 corresponding to the answer indicated by the answer range 1220 are generated for the passage 1200. Note that the character string “Certificate of Suspension” included in the question 1221 in the example illustrated in FIG. 6 is not “Certificate of Suspension” in the answer range 1220 of the passage 1200, but is a copy of “Certificate of Suspension” of “Certificate of Suspension” can be issued upon request from policyholder” of the passage 1200.

Thus, it is seen that in the generation apparatus 10 of the embodiment of the present invention, an answer range is extracted from each passage, and a question corresponding to an answer indicated by the answer range is appropriately generated.

(First) Modification

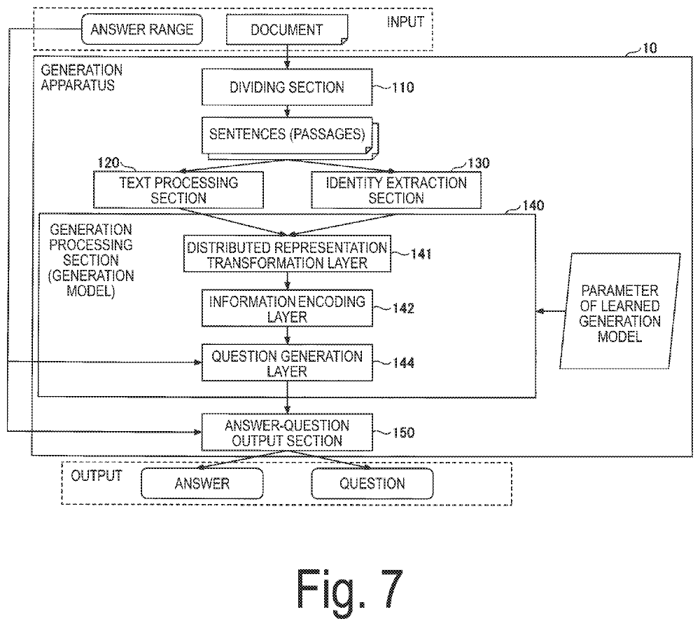

Next, a functional configuration of the generation apparatus 10 of a (first) modification is described with reference to FIG. 7. FIG. 7 is a drawing illustrating a modification of the functional configuration (generation of answers and questions) of the generation apparatus 10 of the embodiment of the present invention.

As illustrated in FIG. 7, when an answer range is input to the generation apparatus 10, the generation processing section 140 of the generation apparatus 10 may not include the answer extraction layer 143. In this case, the question generation layer 144 of the generation processing section 140 generates a question from the input answer range. Note that even in the case where an answer range is input to the generation apparatus 10, a mask process may be provided when a question is generated at the question generation layer 144.

In addition, the answer-question output section 150 outputs an answer indicated by the input answer range and a question corresponding to the answer.

Note that in the (first) modification, the answer range is input to the generation apparatus 10, and therefore it suffices that in learning, the parameter of the generation model is updated such that only an error between a correct question and an estimated question is minimized.

(Second) Modification

Next, a (second) modification is described. The generation apparatus 10 of the embodiment of the present invention learns a generation model with a learning corpus composed of a three pair of a question, a passage, an answer range as training data. The generation apparatus 10 may learn a generation model with a keyword set indicating a question, a passage, an answer range as training data, instead of the training data. In this manner, in generation of answers and questions, a keyword set indicating a question (in other words, a set of keywords likely to be used in questions) may be generated instead of a question.

Here, in the case where an answer of a question is searched using a common search engine, users often input a key word set rather than a natural sentence as a query. For example, as a query for searching an answer for a question “the company that held the R&D forum?”, a keyword set “R&D forum, hold, company” and the like are often input in many cases.

Alternatively, even when a user inputs a natural sentence as a query, a process of deleting an inadequate word as a search keyword and the like from the natural sentence is performed in some cases during preprocessing of a search engine and the like.

Accordingly, in the case where the present invention is applied to a system for presenting an answer for a user's question using a search engine, a more appropriate answer can be presented for the user's question by preparing pairs of questions and answers in accordance with the format of the query actually used for the searching. That is, in such a case, more appropriate answers can be presented by generating a set of keywords likely to be used for a question rather than generating a question (sentence).

In view of this, as described above, by learning a generation model with a keyword set indicating a question, a passage, and an answer range as training data, the generation apparatus 10 can generate an answer (included in a passage) and a keyword set indicating a question, which is a keyword set for searching the answer from a search engine. In this manner, for example, words that become noise in searching can be eliminated in advance. In addition, since a keyword set indicating a question, rather than a question sentence, is generated, it is possible to avoid a situation where a word embedded between keywords is mistakenly generated when generating a question sentence, for example.

Note that a keyword set indicating a question as training data can be created by extracting only content words or filtering based on parts of speech through morphological analysis and the like performed on a question contained in a learning corpus, and the like, for example.

### CONCLUSION

As described above, the generation apparatus 10 of the embodiment of the present invention can generate an answer and a question related to the answer without specifying an answer range in the passage from a document including one or more passages (or a passage) as an input. In view of this, according to the generation apparatus 10 of the embodiment of the present invention, by only giving a document (or a passage), numerous questions and answers for questions can be automatically generated. Accordingly, for example, FAQ can be automatically created, and a question-and-answer chatbot can be readily achieved.

In the related art, FAQ, which is “frequently asked questions” related to commodity products, services and the like, has to be manually created. With the generation apparatus 10 of the embodiment of the present invention, numerous QA pairs of an FAQ can be readily created in such a manner that a document including an answer range is set as answers (A) and question sentences automatically generated are set to questions (Q).

In addition, many question-and-answer chatbots work on a mechanism called a scenario scheme. The scenario scheme is an operation scheme close to FAQ searching through preparation of numerous QA pairs (see, e.g., JP-2017-201478A). As such, by inputting a product manual, a profile document of a chatbot and the like to the generation apparatus 10, numerous QA pairs of questions (Q) and answers (A) from the chatbot can be created, and thus a chatbot that can answer a wide variety of questions can be achieved while reducing the creation cost of the chatbot, for example.

Further, as described above, in the generation apparatus 10 of the embodiment of the present invention, copying of a word from an answer range in generation of a word included in a question is prevented. In this manner, generation of questions that can be answered by YES/NO can be prevented, and thus pairs of questions and answers suitable for FAQs and chatbots can be generated, for example. Thus, with the generation apparatus 10 of the embodiment of the present invention, the necessity of corrections and maintenances of pairs of generated questions and answers can be eliminated, and the cost of the corrections and maintenances can be saved.

Note that in the case where a generation model is configured using a plurality of neural networks, a specific layer (such as the information encoding layer 142) can be shared between a neural network including the answer extraction layer 143 and a neural network including the question generation layer 144, for example.

The present disclosure is not limited to the disclosure of above-described embodiment, and various modifications and alterations may be made without departing from the scope of the claims.

### REFERENCE SIGNS LIST

10 Generation apparatus
110 Dividing section
120 Text processing section
130 Identity extraction section
140 Generation processing section
141 Distributed representation transformation layer
142 Information encoding layer
143 Answer extraction layer
144 Question generation layer
150 Answer-question output section
160 Parameter updating section

1. A generation apparatus comprising:
a generator configured to use a machine learning model learned in advance, with a document as an input, to generate a question representation for a range of an answer in the document, wherein,
when generating a word of the question representation by performing a copy from the document, the generator adjusts a probability that a word included in the range is copied.

2. The generation apparatus according to claim 1, wherein the generator adjusts the probability that the word included in the range is copied to zero or a minute value.

3. The generation apparatus according to claim 1, wherein the generator generates each word of the question representation by a probability indicated by a weighted sum of a generation probability of a word output by a neural network used for an encoder-decoder model and the probability that the word included in the range is copied.

4. The generation apparatus according to claim 1, wherein the question representation is a question sentence, or a keyword set indicating a question.

5. A learning apparatus comprising:
a generator configured to use a machine learning model, with a document as an input, to generate a question representation for a range of an answer in the document; and
a learner configured to learn a parameter of the machine learning model by using at least an error between the question representation and a correct question representation for the question representation, wherein,
when generating a word of the question representation by performing a copy from the document, the generator adjusts a probability that a word included in the range is copied.

6. A method for generating a question, the method comprising:
generating, by a generator using a machine learning model learned in advance, with a document as an input, a question representation for a range of an answer in the document, wherein
the generator adjusts a probability that a word included in the range is copied when generating a word of the question representation by performing a copy from the document.

7. (canceled)

8. The generation apparatus according to claim 2, wherein the generator generates each word of the question representation by a probability indicated by a weighted sum of a generation probability of a word output by a neural network used for an encoder-decoder model and the probability that the word included in the range is copied.

9. The generation apparatus according to claim 2, wherein the question representation is a question sentence, or a keyword set indicating a question.

10. The generation apparatus according to claim 3, wherein the question representation is a question sentence, or a keyword set indicating a question.

11. The learning apparatus according to claim 5, wherein the generator adjusts the probability that the word included in the range is copied to zero or a minute value.

12. The learning apparatus according to claim 5, wherein the generator generates each word of the question representation by a probability indicated by a weighted sum of a generation probability of a word output by a neural network used for an encoder-decoder model and the probability that the word included in the range is copied.

13. The learning apparatus according to claim 5, wherein the question representation is a question sentence, or a keyword set indicating a question.

14. The learning apparatus according to claim 11, wherein the generator generates each word of the question representation by a probability indicated by a weighted sum of a generation probability of a word output by a neural network used for an encoder-decoder model and the probability that the word included in the range is copied.

15. The learning apparatus according to claim 11, wherein the question representation is a question sentence, or a keyword set indicating a question.

16. The learning apparatus according to claim 12, wherein the question representation is a question sentence, or a keyword set indicating a question.

17. The method according to claim 6, wherein the generator adjusts the probability that the word included in the range is copied to zero or a minute value.

18. The method according to claim 6, wherein the generator generates each word of the question representation by a probability indicated by a weighted sum of a generation probability of a word output by a neural network used for an encoder-decoder model and the probability that the word included in the range is copied.

19. The method according to claim 6, wherein the question representation is a question sentence, or a keyword set indicating a question.

20. The method according to claim 17, wherein the generator generates each word of the question representation by a probability indicated by a weighted sum of a generation probability of a word output by a neural network used for an encoder-decoder model and the probability that the word included in the range is copied.

21. The method according to claim 17, wherein the question representation is a question sentence, or a keyword set indicating a question.
